(19) United States
(12) Patent Application Publication
(10) Pub. No.: US 2026/0360125 A1
(43) Pub. Date: Nov. 12, 2026

(54) MACHINE LEARNING BASED OPTIMIZATION OF SEARCH AND IDENTIFICATION OF MEDIA EFFECTS

(71) Applicant: Google LLC, Mountain View, CA (US)

(72) Inventors: Sanuj Sharma, Los Angeles, CA (US); Amir Hussain Memon, Tustin, CA (US); Scott Aaron Goldwater, Beverly Hills, CA (US); Muhammad Essa Saeed, Lynnwood, WA (US); Rene Nahele Patnode, San Bruno, CA (US)

(21) Appl. No.: 19/200,114

(22) Filed: May 6, 2025

(51) Int. Cl. G06V 10/774; G06F 16/41; G06F 16/483; H04L 67/306

(52) U.S. Cl. CPC G06V 10/774; G06F 16/41; G06F 16/483; H04L 67/306

(57) ABSTRACT

Methods, systems, and apparatus for generating labels for media effects. The techniques include utilizing one or more machine learning models to process effects data to generate a set of labels that describe the characteristics of the media effect. The labels, along with the identity of the corresponding media effect, are stored in an effects label database. When an effects platform receives a query with keywords, where the query instructs the platform to provide a set of related effects based on the keywords, the platform can compare the keywords with the labels stored in the effects label database, and return the identity of the effects whose labels are a closest match to the keywords.

### TECHNICAL FIELD

This specification relates to media effects, and more particularly to systems and methods for machine-learning based optimization of search and identification of media effects.

### BACKGROUND

Effects can refer to modification or enhancements that can be applied to media such as images or videos. One example of an effect is “posterize,” which can transform an image or one or more frames of a video into a poster-like appearance. Many applications allow users to apply effects to media. In such applications, the user may select an effect provided by the application and request the application to modify the media with the selected effect. The application may provide several effects for the user to choose from. For example, the application may present a list of effects to the user on a user interface, from which the user can select the desired effect. The application, or a backend server on behalf of the application, can obtain the identified effect and apply the same to a user-identified image or video.

In some instances, the number of effects can be in the hundreds or thousands or even millions. One contributing factor to the large number of effects is that users themselves can create effects and make them available for other users to use. That is, when the user creates an effect, that effect can be stored in an effects repository and provided to other users.

### SUMMARY

This specification describes techniques for providing media effects to users. Users can process media (e.g., images, videos) with the media effect to modify the media effect based on the specification of the media effect. In some instances, users may create media effects that can be provided to other users. In such instances, the media effects created by the users can be stored in a media effects repository, from which identities of media effects can be retrieved and provided to the user for selection. In some examples, the media effects data stored in the media effects repository can include effects labels that help identify the characteristics of the media effect. The characteristics of the media effect can include, for example, a description of the transformation carried out by the media effect. The effects labels can facilitate searching for or categorizing media effects stored in the media effects repository. In some instances, the effects labels can be provided by the creator of the media effect. These creator-provided effect labels may not accurately describe the characteristics of the media effect. In some implementations, an effects label generating engine can be deployed and which utilizes one or more machine learning models to generate effect labels. Using machine learning models can facilitate the generation of labels that more accurately and comprehensively describe the media effect. As a result, when a user submits a search query for an effect, the application or a backend server in communication with the application can provide a more accurate list of media effects to the user (relative to what may otherwise be provided when searching for effects without such augmented label data/information).

An effects label generation engine can receive, as input, effect data, which can include effect metadata, effects creator provided labels, effect implementing media (e.g., images or videos) videos with and without the effect, etc. Based on the effect data, the one or more machine learning models can generate a set of labels, which can be stored in an effects label database in association with one or more corresponding media effect. When a user query is received, where the query includes one or more keywords, the keywords are compared with the labels stored in the effects label database, and the identities of the effects corresponding to the matched labels can be provided to the user. In some examples, an inverted index can be generated using data in the effects repository, where the inverted index is indexed by effects labels, and each effects label is associated with one or more media effects, or identities of media effects. When a query with keywords is received, the keywords can be compared with the effect labels in the inverted index to identify one or more effects labels that match the keywords and retrieving media effects or identities of media effects associated with the matched effect labels. In some examples, the effects label database can store embeddings of the labels. In such instances, embeddings of the keywords provided in the user query can be generated and compared with the embeddings of the labels in the embeddings vector space. The labels related to the keywords can be determined based on dot product similarity or nearest neighbor similarity. Media effects or identities of media effects associated with the related labels can be identified and provided in response to a search query.

In some examples, the one or more machine learning models can be instructed, using prompts, to generate a specific set of data in a specific format. For example, prompts can instruct the one or more machine learning models to generate aliases/synonyms, functionality, keywords and tags, etc. for an effect. In some examples, the one or more machine learning models can include image labeling models and video labeling models that generate a set of labels based on the images and videos modified by the effect. In some instances, a large language model can be utilized to further expand the set of labels. In some examples, the machine learning model can be provided with a base media file and a modified media file that is the base media file modified by the effect. The machine learning model can determine the differences between pairs of base media files and modified media files to generate a set of labels.

Particular examples of the subject matter described in this specification can be implemented so as to realize one or more of the following advantages. By generating the labels for media effects using one or more machine learning models, the generated labels can be more accurate and comprehensive than manually generated labels. While the creators of such effects may provide keywords that represent the characteristics of the effects, the creator provided keywords may not accurately reflect the characteristics of the effects. As a result, when a user is presented with the effects on a catalog or in response to a search query, the effects presented to the user may not accurately reflect the effects that the user is actually looking for. Media labels generated by the one or more machine learning models can provide a more accurate representation of the characteristics of the media effects compared to that provided by creator generated keywords. Providing accurate search results is one advantage of generating effects labels that accurately reflect the characteristics of the media effects. The accuracy of the search results where machine learning models generate media labels is better than the accuracy of search results where the media labels are creator generated. The improvement in accuracy in search results, in turn, reduces the time needed to provide the search results to the user. This is because for one, inaccurate search results can result in the user sending repeated search queries to the server for the media effect that best matches the keywords. By improving the accuracy of the search result, the number of repeated search queries to the server can be reduced. As a result, the time needed for the user to find the appropriate media effect is reduced. Further, improving the accuracy of the search results may reduce the number of items in the search result that have to be transmitted to the user. A reduction in the number of items, in turn, can reduce the amount of data that is transmitted from the server to the user's device. Reducing the amount of transmitted data can reduce latency of transmission of that data to the user's device, the memory requirement at the user's device, as well as the power consumption at the user's device. In addition, reduction in the amount of transmitted data can reduce network traffic, and thereby bandwidth.

The above-described advantages with respect to search results can also be achieved when the user is presented with a catalog of effects for selection. A catalog of media effects can be provided to the user without the user specifically sending a search query with keywords to the server. Instead, for example, the server may provide the user icons or images representing media effects in response to the user selecting a link “catalog” (or other such links) on the user application. The catalog can allow the user to select one or more categories, and within each selected category the catalog can display icons or images representative of media effects associated with that category.

In some instances, storing the inverted index at the user's device can reduce the latency with which search results are presented to the user and reduces the amount of data communicated from the effects platform to the user's devices. For example, with the inverted index stored at the user's device, the search query from the user can be locally serviced by a search engine on the user's device. The search engine, much like the search engine at the effects platform, can search the locally stored inverted index to identify the labels associated with the search query. This alleviates the need for the search query to be communicated to the effects platform, thereby reducing burden on resources at the user device (resources such as battery, processing, memory, etc.). Once the identities of the labels are identified at the user's device, the user application can communicate the identities to the effects platform to request data related to the identified labels.

The accuracy of the labels generated by the one or more machine learning models can be further improved by providing effects metadata to the model, where the effects metadata can include title, description, author labels, and location labels of the effects. In some instances, providing the location of the provider or a video viewing history of the provider to the model, the model can generate labels with more accurate description.

The labels can also be used to help rank effects that are displayed to the user on the user device. In particular, the labels of the effects the user likes, has saved, or has created a video with, can be used to find other similar effects when the user browses effects from the repository. The ranked effects presented to the user can facilitate a faster selection of the effects by the user.

The labels can be further used to improve the quality of the videos generated by the user. In particular, when a user is creating a video, one or more effects related to the labels can be suggested to the user if the system determines that using the one or more effects can improve the quality of the video.

One general aspect includes a system. The system includes one or more processors and a memory including an effect repository storing effect identification data identifying a plurality of media effects and corresponding label data for the plurality of media effects, wherein the label data includes a respective set of labels descriptive of each of the plurality of media effects and wherein a media effect is a visual effect that is operable to modify a digital media file, and stored instructions that when executed by the one or more processors, cause the one or more processors to perform operations, including: receiving a first set of effect data corresponding to a first media effect; generating, using one or more machine learning models and based on the first set of effect data, a first set of labels describing the first media effect; storing, in the effect repository, an identification of the first media effect and the generated first set of labels for the first media effect; receiving, from a user device, a query requesting identification of a particular media effect; determining, based on data from the effect repository, an identification of one or more media effects that are responsive to the query; and transmitting, to the user device, the identification of the one or more media effects.

In some aspects, the operations further include: generating, an inverted index using the generated set of labels for the plurality of media effects, and determining the identification of the one or more media effects based on the query and the inverted index. In some aspects, the operations further include storing at least a portion of the inverted index at the user device. In some aspects, the operations further include generating a plurality of media effect embeddings corresponding to the plurality of media effects, each media effect embedding of the plurality of media effect embeddings being a vector representation of the label data of the corresponding media effect of the plurality of media effects; generating a query embedding based on the query requesting identification of a particular media effect, the query embedding being a vector representation of the query; and identifying the media effect embedding from the plurality of media effect embedding based on determining a dot product or a nearest neighbor similarity between the media effect embedding and the query embedding.

In some aspects, the first set of effect data includes an image of the effect, and wherein the one or more machine learning models includes an image labeling model that generates the first set of labels based on the image of the effect. In some aspects, the first set of effect data includes a video modified by the corresponding effect, wherein the one or more machine learning models include a video labeling model that generates the first set of labels based on the video. In some aspects, the video labeling model is pretrained on a plurality of media files modified by a corresponding effect from a plurality of media effects.

In some aspects, the first set of labels is an expanded first set of labels, the operations further including: generating a first intermediate set of labels using the one or more machine learning models, and generating the expanded first set of labels based on a large language model receiving as input the first intermediate set of labels. In some aspects, the effect data includes at least one of titles, description, author labels, user labels, or location labels. In some aspects, the first set of labels is generated using the one or more machine learning models based additionally on a user profile of a user authoring the first media effect, the user profile including at least one of video viewing history or the user or a location of the user. In some aspects, the operations further include generating, using the one or more machine learning models, a set of user related keywords based on a user profile associated with the query, the user profile including at least one of a video viewing history of the user or a location of the user; and determining, based on the data from the effect repository, the identification of one or more media effects that are responsive to the query and the set of user related keywords.

In some aspects, the one or more machine learning models includes a multimodal generative artificial intelligence (generative AI) model, the first set of media effect data includes at least one base media file and corresponding at least one modified media file generated based on the at least one base media file modified by the first effect, and the generative AI model generating the first set of labels in response to a zero-shot prompt instructing the generative AI to identify differences between the at least one base media file and the corresponding at least one modified media file.

In some aspects, the zero-shot prompt includes instructions for generating the set of labels based additionally on media effect metadata. In some aspects, the zero-shot prompt additionally instructs the multimodal generative-AI model to account for a user profile of a user authoring the media effect in generating the first set of labels, the user profile including at least one of a video viewing history of the user or a location of the user.

One general aspect includes one or more non-transitory computer-readable storage media storing instructions that when executed by one or more processors cause the one or more processors to perform operations including: receiving a first set of effect data corresponding to a first media effect, wherein a media effect is a visual effect that is operable to modify a digital media file; generating, using one or more machine learning models and based on the first set of effect data, a first set of labels describing the first media effect; storing, in an effect repository, an identification of the first media effect and the generated first set of labels for the first media effect, wherein the effect repository stores effect identification data identifying a plurality of media effects and corresponding label data for the plurality of media effects, wherein the label data includes a respective set of labels descriptive of each of the plurality of media effects; receiving, from a user device, a query requesting identification of a particular media effect; determining, based on data from the effect repository, an identification of one or more media effects that are responsive to the query; and transmitting, to the user device, the identification of the one or more media effects.

In some aspects, the operations further include: generating, an inverted index using the generated set of labels for the plurality of media effects, and determining the identification of the one or more media effects based on the query and the inverted index. In some aspects, the operations further include storing at least a portion of the inverted index at the user device. In some aspects, the operations further include generating a plurality of media effect embeddings corresponding to the plurality of media effects, each media effect embedding of the plurality of media effect embeddings being a vector representation of the label data of the corresponding media effect of the plurality of media effects; generating a query embedding based on the query requesting identification of a particular media effect, the query embedding being a vector representation of the query; and identifying the media effect embedding from the plurality of media effect embedding based on determining a dot product or a nearest neighbor similarity between the media effect embedding and the query embedding.

In some aspects, the first set of effect data includes an image of the effect, and wherein the one or more machine learning models includes an image labeling model that generates the first set of labels based on the image of the effect. In some aspects, the first set of effect data includes a video modified by the corresponding effect, wherein the one or more machine learning models include a video labeling model that generates the first set of labels based on the video. In some aspects, the video labeling model is pretrained on a plurality of media files modified by a corresponding effect from a plurality of media effects.

In some aspects, the first set of labels is an expanded first set of labels, the operations further including: generating a first intermediate set of labels using the one or more machine learning models, and generating the expanded first set of labels based on a large language model receiving as input the first intermediate set of labels. In some aspects, the effect data includes at least one of titles, description, author labels, user labels, or location labels. In some aspects, the first set of labels is generated using the one or more machine learning models based additionally on a user profile of a user authoring the first media effect, the user profile including at least one of video viewing history or the user or a location of the user. In some aspects, the operations further include generating, using the one or more machine learning models, a set of user related keywords based on a user profile associated with the query, the user profile including at least one of a video viewing history of the user or a location of the user; and determining, based on the data from the effect repository, the identification of one or more media effects that are responsive to the query and the set of user related keywords.

In some aspects, the one or more machine learning models includes a multimodal generative artificial intelligence (generative AI) model, the first set of media effect data includes at least one base media file and corresponding at least one modified media file generated based on the at least one base media file modified by the first effect, and the generative AI model generating the first set of labels in response to a zero-shot prompt instructing the generative AI to identify differences between the at least one base media file and the corresponding at least one modified media file.

In some aspects, the zero-shot prompt includes instructions for generating the set of labels based additionally on media effect metadata. In some aspects, the zero-shot prompt additionally instructs the multimodal generative-AI model to account for a user profile of a user authoring the media effect in generating the first set of labels, the user profile including at least one of a video viewing history of the user or a location of the user.

One general aspect includes a method for execution on a computing system for management of media effects and respective media labels. The method also includes receiving, at the computing system, a first set of effect data corresponding to a first media effect, where a media effect is a visual effect that is operable to modify a digital media file; generating, at the computing system, using one or more machine learning models and based on the first set of effect data, a first set of labels describing the first media effect; storing, in an effect repository communicably coupled with the computing system, an identification of the first media effect and the generated first set of labels for the first media effect, where the effect repository stores effect identification data identifying a plurality of media effects and corresponding label data for the plurality of media effects, where the label data includes a respective set of labels descriptive of each of the plurality of media effects. The method also includes receiving, at the computing system from a user device, a query requesting identification of a particular media effect. The method also includes determining, at the computing system, based on data from the effect repository, an identification of one or more media effects that are responsive to the query. The method also includes transmitting, by the computing system to the user device, the identification of the one or more media effects.

In some aspects, the method may include: generating, at the computing system, an inverted index using the generated set of labels for the plurality of media effects, and determining, at the computing system, the identification of the one or more media effects based on the query and the inverted index. In some aspects, the method may include: transmitting, by the computing system to the user device, at least a portion of the inverted index for storage at the user device. In some aspects, the method may include: generating, at the computing system, a plurality of media effect embeddings corresponding to the plurality of media effects, each media effect embedding of the plurality of media effect embeddings being a vector representation of the label data of the corresponding media effect of the plurality of media effects; generating, at the computing system, a query embedding based on the query requesting identification of a particular media effect, the query embedding being a vector representation of the query; and identifying, at the computing system, the media effect embedding from the plurality of media effect embedding based on determining a dot product or a nearest neighbor similarity between the media effect embedding and the query embedding. The first set of effect data includes an image of the effect, and where the one or more machine learning models includes an image labeling model that generates the first set of labels based on the image of the effect. The first set of effect data includes a video modified by the corresponding effect, where the one or more machine learning models include a video labeling model that generates the first set of labels based on the video. The video labeling model is pretrained on a plurality of media files modified by a corresponding effect from a plurality of media effects. The first set of labels is an expanded first set of labels, the method may include: generating, at the computing system, a first intermediate set of labels using the one or more machine learning models, and generating, at the computing system, the expanded first set of labels based on a large language model receiving as input the first intermediate set of labels. The effect data includes at least one of titles, description, author labels, user labels, or location labels. The first set of labels is generated using the one or more machine learning models based additionally on a user profile of a user authoring the first media effect, the user profile including at least one of video viewing history or the user or a location of the user.

In some aspects, the method may include: generating, at the computing system, using the one or more machine learning models, a set of user related keywords based on a user profile associated with the query, the user profile including at least one of a video viewing history of the user or a location of the user; and determining, at the computing system, based on the data from the effect repository, the identification of one or more media effects that are responsive to the query and the set of user related keywords. The one or more machine learning models includes a multimodal generative artificial intelligence (generative ai) model, where the first set of media effect data includes at least one base media file and corresponding at least one modified media file generated based on the at least one base media file modified by the first effect, and where the generative ai model generating the first set of labels in response to a zero-shot prompt instructing the generative ai to identify differences between the at least one base media file and the corresponding at least one modified media file. The zero-shot prompt includes instructions for generating the set of labels based additionally on media effect metadata. The zero-shot prompt additionally instructs the multimodal generative-ai model to account for a user profile of a user authoring the media effect in generating the first set of labels, the user profile including at least one of a video viewing history of the user or a location of the user.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which an effects platform facilitates the use of effects by users.

FIG. 2A shows a first example user interface where a set of effects are displayed in the form of a catalog for user selection.

FIG. 2B shows a second example user interface including a search field where a user can enter keywords for searching effects.

FIG. 3 shows an example block diagram of an example system for generating labels for effects.

FIG. 4A shows an example input provided to a machine learning model for generating label data.

FIG. 4B shows a portion of an example output of the generative-AI model that was provided the example input shown in FIG. 4A.

FIG. 5 depicts another example approach to generating effects labels.

FIG. 6 shows a block diagram of a system for generating labels based on a base video file.

FIG. 7 shows a flow diagram of an example process for generating labels for effects.

Like reference numbers and designations in the various drawings indicate like elements.

### DETAILED DESCRIPTION

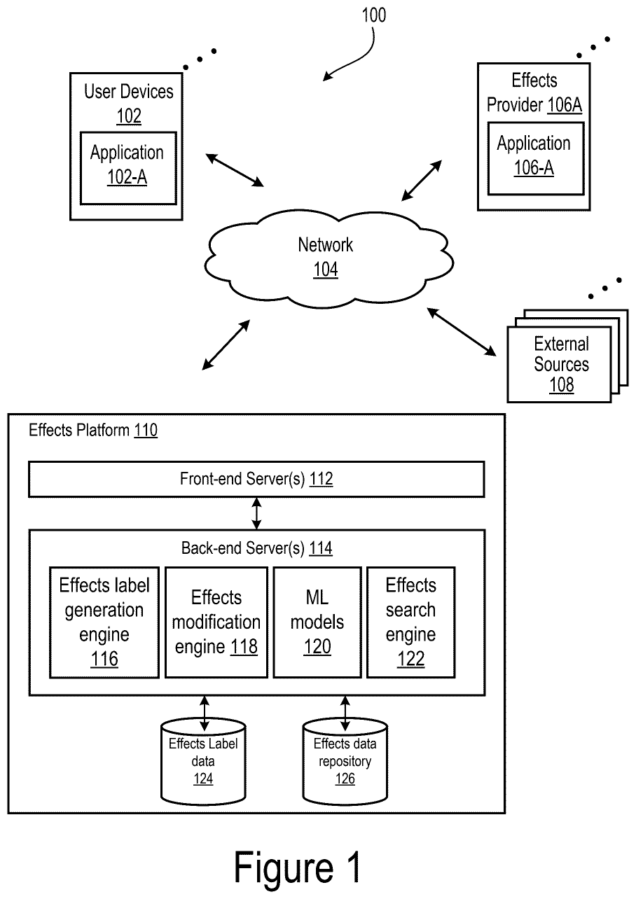

FIG. 1 is a block diagram of an example environment 100 in which an effects platform facilitates the use of effects by user devices. The example environment 100 includes a network 104, such as a local area network (LAN), a wide area network (WAN), the Internet, or a combination thereof. The network 104 connects one or more user devices 102, one or more effects provider devices 106, an effects platform 110, and one or more external sources 108.

User device 102 and provider device 106 are electronic devices that can communicate content over the network 104. Examples of such devices include personal computers, mobile communication devices, digital assistant devices, and other devices that can send and receive data over the network 108.

The effects platform 110 is a computing platform that can be maintained and operated by one or more effects providers. The effects platform 110 enables providers to list their effects on the effects platform 110 and enables users to select and use the effects listed on the effects platform 110. As depicted in the block diagram of FIG. 1, the effects platform 110 is depicted as a single block with various sub-blocks. However, while the effects platform 110 could be a single device or single set of devices, this specification contemplates that the effects platform 110 could also be a group of devices, or even multiple different systems that communicate with each other to enable the exchange of effects on the platform. The effects platform 110 could also be a provider of effects or may be an entity different from the provider, as shown in FIG. 1.

An effects provider uses an application 106-A executing on the effects provider device 106 to communicate with the effects platform 110 to, for example, communicate and manage effects created by the provider on the effects platform 110. The application 106-A (or another dedicated effects creation application running on the user device or an application running on a remote server with a user interface provided by the application 106-A or another application on the user device 106) can enable the provider to create new effects. In one approach, the application 106-A can include one or more selectable effects that the provider can select in specific permutations and combinations to create their own effect. The application 106-A can create an effects file that corresponds to the effect created by the provider. In another approach, the application 106-A can allow the user to upload an effect file corresponding to a provider created effect that the provider created on another application or created previously on the application 106-A. In some examples, the effect file can have a structure that includes assets, a face_paint_image, a face_sticker_image, a 3d_model, and project data, which in turn can include a binary representation of the effect. The images and models can be specific to the effect and can provide representation of the effect. The project data can include the “scene” objects that can reference assets within the effects file structure. The project data can also include a visual script for the user's effect that can reference scene objects and assets and can be a visual representation of the user's effect program code. The project data can also include a state of the user interface or the user's effect (e.g., initial state of the sliders, dropdowns, etc.) which can describe how the effect initially appears. The application 106-A can communicate the provider created effects to the effects platform 110.

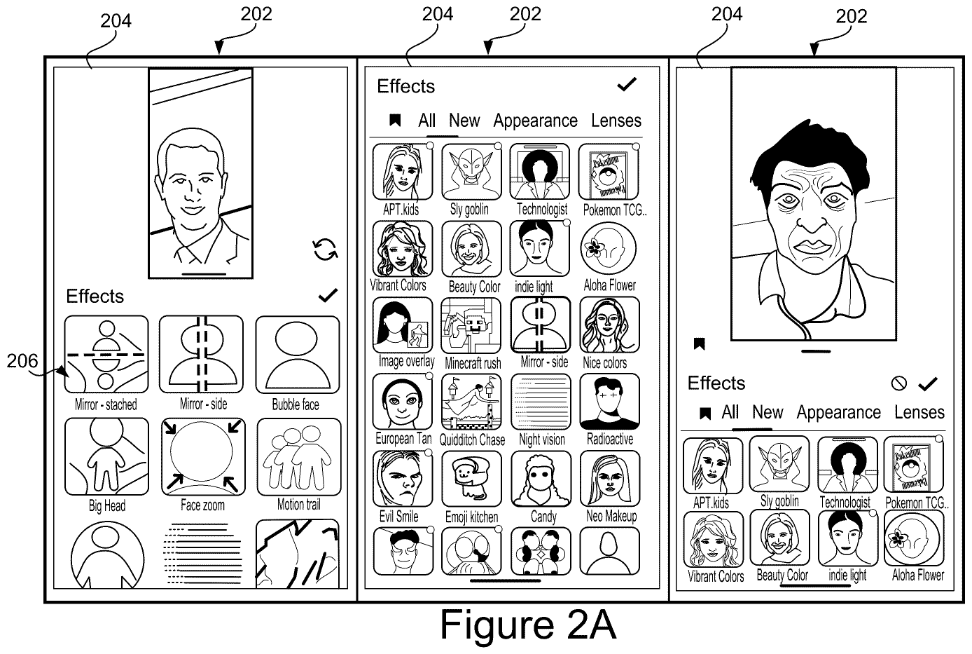

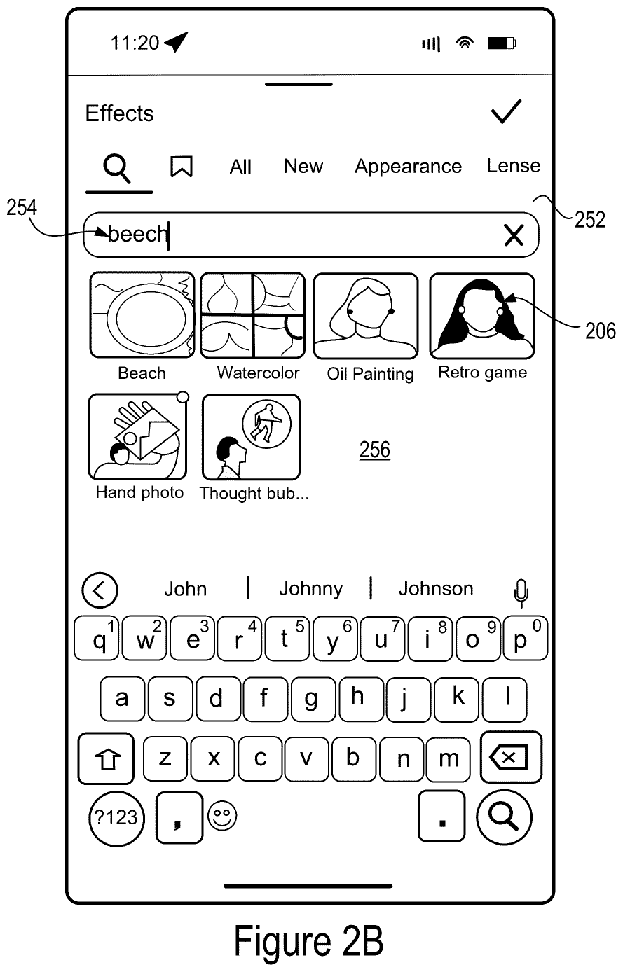

Users of the user device 102 can use an application 102-A to view a catalog of selectable effects on the application. The application 102-A can also provide the user a user interface to enter keywords, which the application 102-A can communicate to the effects platform 110, and in response receive information on a set of effects from the effects platform 110. The application 102-A can display the set of effects received from the effects platform 110 to the user for selection. The application 102-A can also provide the user the ability to apply the selected effects on the selected media. The user can select media on which the effects are applied from a media file stored in the user device or downloaded from an external storage device. The user may also select a live feed from a camera on the user's device or another device as the media file which the user can modify with the effects. Examples of the user interface provided by the application 102-A are briefly discussed below in relation to FIGS. 2A and 2B before continuing with the discussion of the example environment 100.

FIG. 2A shows a first example user interface where a set of effects are displayed in the form of a catalog for user selection. In particular, the first example user interface 202 can include a plurality of screens 204 that can be displayed to the user by the application 102-A. Each screen 204 includes a plurality of icons 206 that represent a plurality of effects. The first example user interface 202 may also include a selectable textual list of effects instead of or in addition to the plurality of icons 206. Some of the example effects can include “Bubble face,” “Big head,” “Evil smile,” “Vibrant colors,” “Neo makeup,” etc. The user can select one or more of the plurality of icons 206 to modify media. The first example user interface 202 also includes a live view window 208 that shows the result of the selected effects on a media. For example, the application 102-A can provide the user the ability to select the media that the user would like to transform using one or more effects. The selected media can be displayed in the live view window 208. When the user selects, or hovers over, an effect icon, the application 102-A can apply the transformations associated with the effect(s) identified by the selected effect icon(s) to the media and show the result of the application of the effect(s) on the media on the live view window 208. In this manner, the user can evaluate the various effects before selecting one. The plurality of icons 206 can be categorized and displayed in various tabs. For example, the first example user interface 202 includes tabs entitled “All,” “New,” “Appearance,” and “Lenses.” The tab titles can represent various categories under which the effects represented by the plurality of icons 206 can be organized. In some examples, the embedding platform 110 (e.g., the front-end server 112 or the effects search engine 122) can generate the categories based on the identity of the labels resulting from the search, the keywords provided by the user in the search query, keyword associated with the user's profile (discussed in further detail below), and the like. In some examples, the effects platform 110 can generate the categories based on embeddings generated based on the keywords or labels. Generally, the effects platform 110 can create categories that correspond to clusters of labels or keywords and use the categories to provide the user with an organized list of media effects.

The application 102-A can display the plurality of icons 206 on the first example user interface based on information received from the effects platform 110. The application 102-A can receive from the effects platform information of a plurality of effects, including the icons associated with the effects, the titles of the effects, the code associated with the effect for transforming media, one or more categories associated with the effects, metadata associated with the effects, etc., where the metadata can include, for example, the category associated with the effect. In some examples, the information on the effects may be stored locally on the user device 102 and the application 102-A can display the plurality of icons 206 and the first example user interface 202 based on the locally stored information.

FIG. 2B shows a second example user interface 252 including a search field 254 where a user can enter keywords for searching effects. The second example user interface 252 can be presented to the user on the user device 120 by the application 102-A. The application 102-A can communicate the keywords entered by the user in the search field 254 to the effects platform 110, and in response receive information on effects related to the keywords. The user interface 252 can include an icon display portion 256, not unlike the user interface shown in FIG. 2A, to display the plurality of icons 206 associated with the effects received from the effects platform 110.

Referring again to example environment 100 shown in FIG. 1, the effects platform 110 can include one or more front-end servers 112 and one or more back-end servers 114. The front-end servers 112 can transmit data to, and receive data from, the user devices 102 and the provider devices 106 over the network 104. For example, the front-end servers 112 can provide to, applications 102-A and 106-A executing on user devices 102 and provider devices 106, respectively, interfaces and/or data for presentation with the interfaces. The front-end servers 112 can also receive data specifying user interactions with the user interfaces on the user devices 102 and provider devices 106. The front-end servers 112 can update the interfaces, provide new interfaces, and/or update the data presented by the interfaces in applications 102-A and 106-A, based on user/provider interactions with user devices 102 and provider devices 106.

The front-end servers 112 can also communicate with the back-end servers 114. For example, the front-end servers 112 can identify data to be processed by the back-end servers 114, e.g., data specifying keywords that the back-end servers 114 can use to carry out search operations for related effects. The front-end servers 112 can also receive from the back-end servers 114 data for a particular user of a user device 102 or a provider device 106 and transmit the data to the appropriate user device 102 or provider device 106 over the network 104.

The back-end servers 114 can include an effects search engine 122, an effects label generation engine 116, an effects modification engine 118, and ML models 120. As used in this specification, the term engine refers to hardware, e.g., one or more data processing apparatuses (e.g., one or more processors), that execute software/programming instructions that performs a set of tasks. Although FIG. 1 depicts three engines, the operations of these engines as described in this specification may be performed, wholly or in part, by one or more other engines. In other words, some implementations may include more than the three engines depicted in FIG. 1 to perform the operations described in this specification. Alternatively, some implementations may include fewer engines to perform the operations described in this specification. Further still, even if an implementation includes the same three engines depicted in FIG. 1, the operations performed by one of these engines, as described in this specification, may be performed by one or more of the other engines.

The back-end servers 114 are communicably coupled with one or more data stores such as an effects label database 124 and an effects data database 126. Databases can refer to any data structure for storage and retrieval of data and can be relational or non-relational. The effects label database 124 can store labels associated with effects, and the effects database 126 can store data related to effects such as titles, thumbnail icons, effects code, etc. The effects label database 124 can, for example, store an inverted index, where labels are mapped to one or more effects. For example, the inverted index can include a list of labels and for each label include locations or identities of effects mapped to the label. In some instances, the locations can include locations of effects data in the effects database 126 where details of each effect are stored. An inverted index is only one example data structure to organize information in the effects label database, and other example data structures such as forward index, B-tree index, hash index, etc. may also be used for organizing data in the effects label database 124. The effects labels database 124 can store labels in the form of text, a hash or any other form that is a function of the identity of the label. In some instances, the effects label database 124 can store label embeddings, where the embeddings are vector representations of data points, where each data point represents a label. In some instances, the effects label database 124 and the effects database 126 can be merged into a single database.

The effects search engine 122 can search the effects label database 124 and/or the effects database 126 for effects based on keywords. As discussed above in relation to FIG. 2B, the user can enter keywords to search for related effects. The user application 102-A can communicate the keywords entered by the user to the front-end interface 112, which in turn communicates the keywords to the effects search engine 122. The effects search engine 122 can use the keywords to determine the identity of one or more effects based on searching the effects label database 124. The effects search engine 122 can use the identities of the one or more effects retrieved from the effects label database 124 to retrieve effects data. The effects data can include text identifying the effect, a thumbnail image identifying the effect, the effect code, or other data associated with the effect. The effects search engine 122 can communicate the effects and the associated effects data to the front-end server 112, which in turn communicates the effects and the associated effects data to the user application 102-A. The user application 102-A can then provide the effects and the effect information, for example, in the manner shown in FIG. 2B. The effects search engine 122, in some examples, can generate embeddings of the keywords received from the user application 102-A, and retrieve effects data by matching the embeddings of the keywords with embeddings of labels stored in the effect label database 124.

The effects label generation engine 116 can generate labels based upon information related to an effect. For example, the effects label generation engine 116 may receive an effect from the provider application 106-A (via the front-end server 112). The provider may have generated a new effect or modified an already existing effect. The effects label generation engine 116 can generate labels that closely represent the characteristics of the effect. Once the labels are generated the labels and the effects data can be stored in the effects label database 124 and/or the effects database 126. The effects label generation engine 116 is discussed in more detail below.

The effects modification engine 118 can modify media based on one or more effects. For example, the effects modification engine 118 can modify an image or a video based on one or more effects. The effects data can be received from the user or provider or can be accessed from the effects database 126. In some instances, the user application 102-A may not be capable of carrying out media modifications due to lack of computing resources. In such instances, the user application 102-A can send the media selected by the user and the identity of the one or more effects selected by the user to the effects modification engine 118. The effects modification engine 118 can access the identified effects from the effects database 126 and process the media received from the user with the identified effects. The modified media can then be communicated back to the user application 102-A for display to the user. In some instances, as discussed below, the effects modification engine 118 can be utilized to modify base media with effects created by a provider to determine appropriate label data for the effects.

The ML models 120 can include one or more machine learning models. In some instances, the ML models 120 can include one or more generative-AI models such as large language models (LLMs), image labeling models, video labeling models, etc. The ML models 120 can be multi-modal and can process and generate content based on multiple data types such as text, image, video, and audio. Examples of multi-modal generative AI models can include, without limitation, DALL-E, GPT-4o, ImageBind, Claude 3, Gemini, etc.

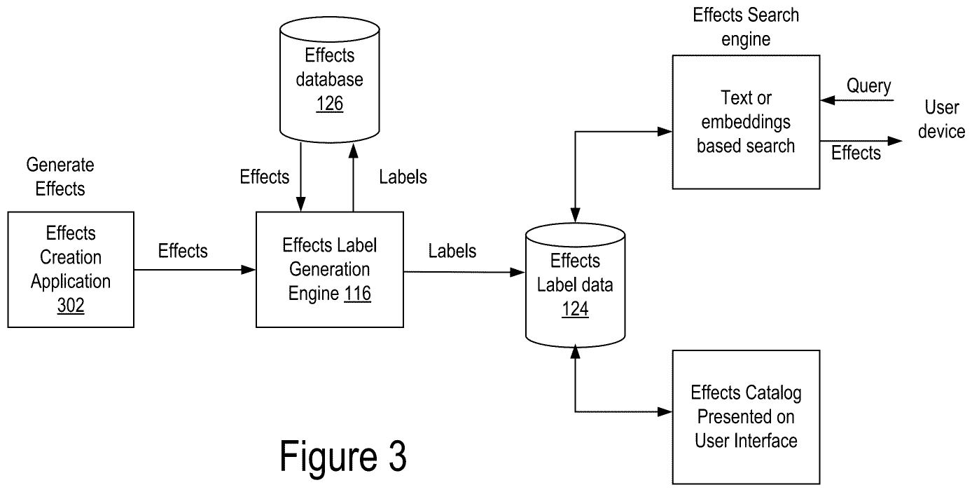

FIG. 3 shows an example block diagram of an example system for generating labels for effects. An effects creation application 302 generates effects, the information of which is provided to the effects label generation engine 116. The effects creation application 302 can allow a provider to create new effects or modify existing effects. As an example, the provider application 106-A can include an effects creation module that allows the provider to create effects. The effects creation module can include an effects compiler, which, based on the characteristics of the effects selected by the provider, can generate a corresponding effects code. At the user device 102, when a user selects to apply an effect on a media, the user application 102-A can execute the effects code to modify the media.

The effects creation application 302 can generate effects metadata in addition to generating the effects code, where the effects metadata can include information provided with the media effect. The effects metadata can include additional information about the effect and can include information about the effect entered by the provider. In some examples, effects creation application can prompt the provider to enter labels that describe the effect. The labels entered by the provider can be included in the effects metadata. The effects creation application 302 may also carry out static analysis of the effect to generate additional effects metadata. Static analysis is a process that is typically carried out during compilation of source code and that examines the source code without executing it to determine potential issues such as coding violations, vulnerabilities, and defects. In some examples, the effects creation application can represent the effects in a manner similar to how objects and material are represented in 3D editors. For example, the definition of an effect can be represented as a set of scenes, where each scene is a container that holds information about an effect (such as modifications) arranged using a tree hierarchy.

The effects compiler can include, for example, a front-end, a middle-end, and a backend. The front-end can traverse a tree hierarchy of a scene of objects in the effect definition, the middle-end can create a tree of expressions that performs optimizations on an intermediate representation, and a backend that converts the trees of expressions into effect code. As mentioned above, the effects creation application 302 can perform static analysis of the effects during the compilation process. The compiler can traverse the various data structures that represent an effect. For example, the compiler can traverse the tree hierarchy of the scene of objects that represent the effect. The compiler has context of what objects are being used in implementing the compiled media effect. For example, using a face paint object in a media effect indicates that the media effect may make use of “face landmarks” such as features of a face to implement the media effect. The compiler can also have the context of what assets are being used, such as using a GIF, which can indicate that the media effect uses animated images as assets. The compiler can also have the context of how the objects are being used to implement the media effect, for example, using a visual scripting node for object tap indicates that the effect reacts to objects within the effect being tapped. The compiler can define renderable scene objects and define render passes based on an order of scene objects in the effect's tree of scene objects. As part of the render passes, the compiler can generate executable code for each of the scene objects. The compiler can then combine all the render passes to generate a final effect code that can be executed to implement the media effect. The compiler, while carrying out render passes, can also take into consideration visual scripts associated with the respective scene object. The static analyses can be leveraged to gather additional information about the effects. For example, the effects creation application 302 can track usage of various features such as, whether face landmarks are used in the effect, what visual scripting nodes or interactions are used in the effect, etc. The effects creation application 302 can include this information in the effects metadata. The media effect created using the effects creation application 302 can include the effect code and the effects metadata, which can include the labels rendered by the provider.

While FIG. 3 shows the effects creation application 302 directly providing the effects data to the effects label generation engine 116, it should be noted that the effects label generation engine 116 may also access the effects data from the effects database 126. The effects database 126 can store the effects data associated with effects generated using the effects creation application 302.

The provider can include a description of the effects by way of labels. As mentioned above, the provider's description of the effects may not accurately describe the characteristics of the effects. In addition, the labels may not fully describe all the characteristics of the effects. Thus, the provider's description of the effects may not be comprehensive enough or accurate enough to facilitate a search for the effect by the user. To improve the quality of the labels associated with the effects, the effects label generation engine 116 can utilize the one or more machine learning models to generate a set of labels that describe the effect.

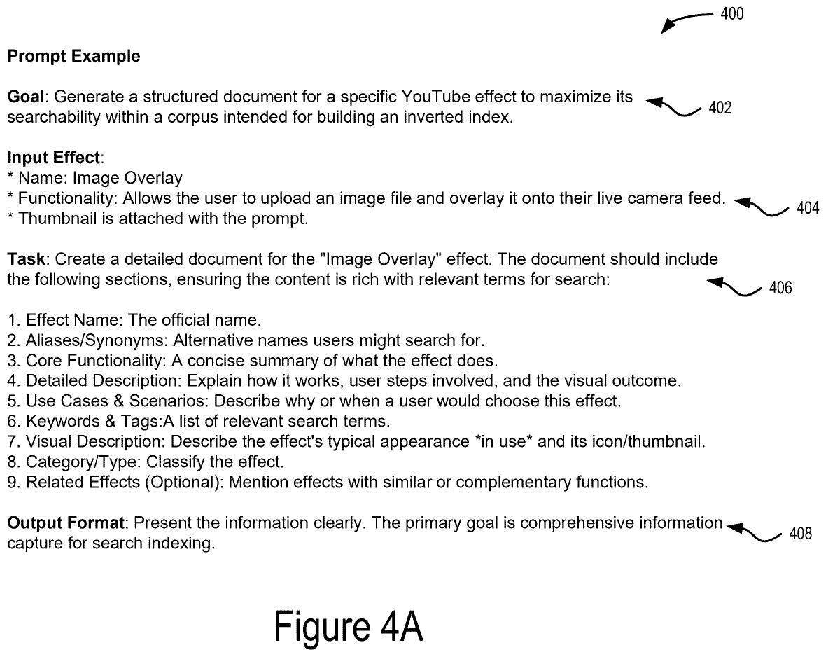

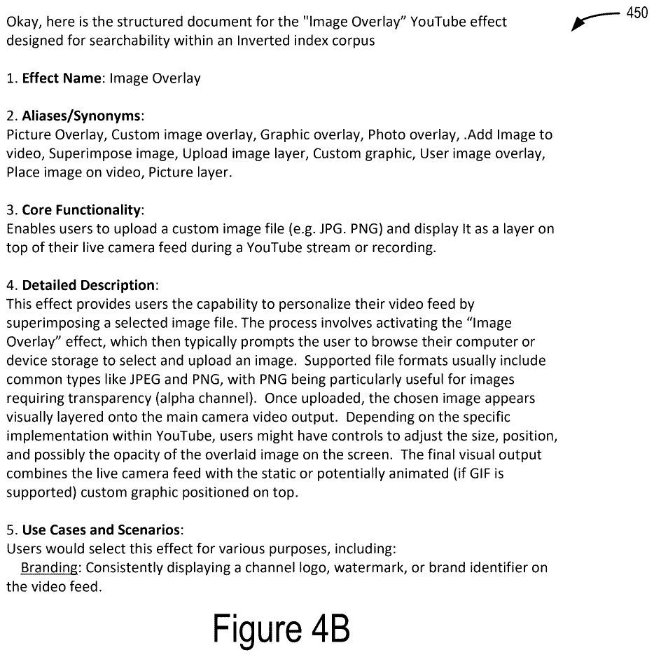

In one example, the effects label generation engine 116 can include a generative-AI model such as a large language model (LLM). Examples of LLMs can include Gemini, LLaVa, GPT-4, and the like. In some examples, these LLMs can be pretrained. In some other examples, the pretrained LLMs can be fine-tuned on a dataset that is specific to label generation. For example, the pretrained LLMs can be trained on data that includes effects data and label data. The generative-AI model can be single-mode or multimodal. While single-mode models process data of a single data type (e.g., text), multimodal models can process data of multiple data types (e.g., text, images, audio, and video). The generative-AI models can receive instructions or prompts and produce data instructed by the prompts. In this example, the generative-AI model can be provided with the effects data and instructed to generate a set of labels and other data that describe the effect. One such example is discussed below in relation to FIGS. 4A and 4B.

The effects label generation engine 116 can store the labels in the effects label database 124. The effects label database 124 can store the labels in association with the identity of the effects. In some instances, as mentioned above, the effects label database 124 can store the labels and the identities of the corresponding effects in a reverse index (or inverted index) data structure, which can be searched by the effects search engine (FIG. 1, 122) to identify the identities of the effects that match a set of keywords provided by a user. In some instances, the effects label database 124 can store embeddings of the labels, instead of merely labels, generated by the effects label generation engine 116. In such instances, the effects search engine 122 can generate embeddings of the keywords provided by the user and compare the embeddings with the label embeddings to identify, e.g., nearest neighboring labels in the embeddings vector space, and thereby identifying the corresponding effects. In some instances, the labels can be utilized to present the effects to the user in the form of a catalog that the user can browse to select an effect. In such instances, the effects can be grouped in various categories where an effect can be shown in one or more categories based on the category and the labels associated with the effect.

Referring again to the effects label generation engine 116, one or more machine learning models can be utilized to generate the set of labels associated with effects. One example of using a machine learning model is described below in relation to FIGS. 4A and 4B.

FIG. 4A shows an example input 400 provided to a machine learning model for generating label data. In particular, FIG. 4A shows a prompt and a set of effect data that can be provided to a generative-AI model. The example input 400 can specify a Goal 402, provide identification information 404 of the Input Effect, specify a Task 406, which specifies a set of content types that the generative-AI model should generate, and an Output Format 408 in which the generative-AI model should generate the output. It should be noted that the example input 400 can vary based on the specific implementation of the system. For example, the example input 400, under Tasks, may only request the generative-AI model to generate Aliases/Synonyms, which the implementation can use as labels associated with the “Image Overlay” effect. In other implementations, the Tasks can include additional sections that those sections shown in FIG. 4A. While not shown in FIG. 4A, the example input 400 may be accompanied with an image that the user would like to overlay over the media.

FIG. 4B shows a portion of an example output 450 of the generative-AI model that was provided by the example input 400 shown in FIG. 4A. The portion of the example output 450 shown in FIG. 4B includes the requested sections: Effect Name, Aliases/Synonyms, Core Functionality, Detailed Description, and Use Cases and Scenarios. For brevity, the remaining sections requested in the example input 400 are not shown. In some examples, the terms listed in the Aliases/Synonyms section can be used as labels for this effect and stored in the effects labels database 124. In some other instances, any portion of or all text of the example output 450 can be stored as labels associated with the effect “Image Overlay.” Thus, if the user searches for an effect that allows the user to display a logo onto the image, the text in the Use Cases and Scenarios can be a match, and the Image Overlay effect, among other effects, can be provided to the user in response to the user query.

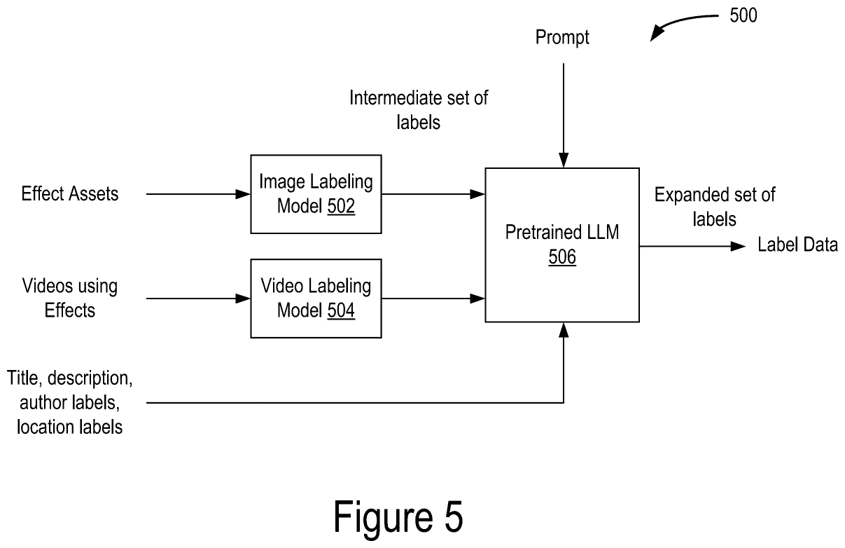

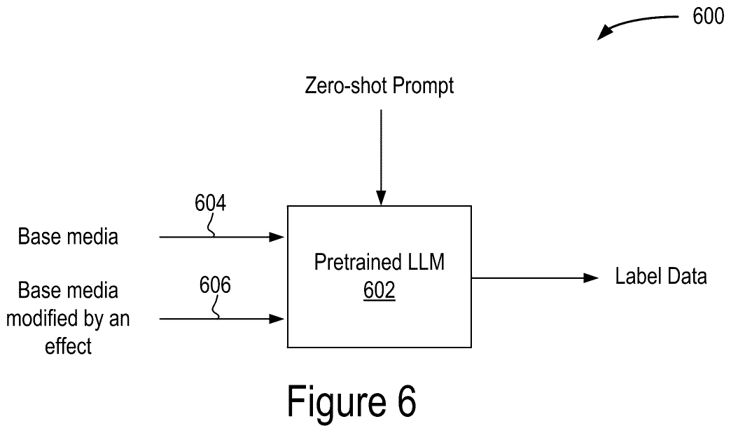

It should be noted that the approach described in relation to FIGS. 4A and 4B is only one example approach to generating labels using one or more machine learning models. Additional approaches to generating effect labels are described below in relation to FIGS. 5 and 6.

FIG. 5 depicts another example approach to generating effects labels. In particular, FIG. 5 shows a block diagram of an example system 500 implementing the effects label generation engine 116. The example system 500 includes an image labeling model 502, a video labeling model 504 and a pretrained LLM 506. The image labeling model 502 can include a pretrained generative-AI model that provides intermediate labels based on effect assets, which can include data provided by the effect creator such as images, GIFs, textures, 3D models, color look-up-tables, audio clips and other media used in the effects. The assets can also include the effect name, the description of the effect, and a thumbnail representing the effect. The assets can further include data generated by the effect creation application such as compiled effect code, synthesized effect videos that simulate user interaction.

The video labeling model 504 can also be a pretrained generative-AI model that also provides intermediate labels based on video data of the effect. Video data can include videos that utilize the same effect for which labels are being generated. Videos provided to the video labeling model 504 can be selected based on one or more aspects. For example, the videos can be popular videos (e.g., measured by the number of views), videos of a minimum quality (e.g., measured by the resolution), videos of specific content (e.g., animation v/s live action), etc. These selected videos can be provided to the generative-AI model with a prompt that instructs the model to generate labels that correspond to common characteristics of the videos. As the videos provided to the video labeling model 504 exhibit the implementation of the same effect, identifying the common characteristics of the videos can be used to represent the characteristics of the effect itself. Examples of generative-AI models that can be used to implement the image labeling model 502 and the video labeling model 504 can include, without limitation, Gemini AI, Vertex-AI, etc.

The intermediate labels generated by the image labeling model 502 and the video labeling model 504 can be provided to a LLM to expand the number of labels. For example, the LLM can be provided with a prompt, similar to the prompt shown in FIG. 4A, where the LLM is instructed to generate a document including a set of sections, which, for example can include Aliases/Synonyms. The LLM can be specifically instructed to generate more labels than the number of intermediate labels generated by the image labeling model 502 and the video labeling model 504. The labels generated by the pretrained LLM 506 can be stored in the effect label database 124 in association with the effect. In some examples, the

In some instances, the pretrained LLM 506 can also be provided with additional information about the effect such as title, description, providers' labels, location labels, etc., to further facilitate the LLM to generate the expanded set of labels. In some instances, user profile information can also be provided to the pretrained LLM 506. The user profile can include the user's browser/watch history, user's location, user's preferences, or other user data that the user permitted sharing with the system. Including the user profile information can help the pretrained LLM 506 to generate labels that take into consideration the user's information. For example, if the user has a history of watching videos of a particular sports team and lives in a city A, then the effects created by the user may be related to the sports team, the sport, or the city A. The pretrained LLM 506, based on the user information, can generate labels that are related to the sport of the sports team or the city A.

Some of the approaches to generating labels discussed herein include generating labels based on videos that have been modified by the effect (e.g., FIG. 5). While the modified videos can provide valuable information of the effects itself, it may be, in some instances, difficult to obtain the modified videos or the labels generated based on the modified videos may accurately describe the characteristics of the media effect. In some such instances, one approach can use a base media file not modified by an effect and the base media file modified by the effect to generate labels. This approach is discussed in relation to FIG. 6.

FIG. 6 shows a block diagram of a system 600 for generating labels based on a base video file. In particular, the system 600 can be used to implement at least a portion of the effects label generation engine 116. The system 600 includes a pretrained LLM 602, which can be similar to the pretrained LLM 506 discussed herein in relation to FIG. 5. The pretrained LLM 602 is provided as inputs a base media file 604. The base media file 604 can include an image or a video file. The pretrained LLM 506 is also provided as input a modified file 606, which is the base media of the base media file 604 modified by the effect. The pretrained LLM 606 can be instructed, using a prompt (e.g., a zero-shot prompt), to compare the visual features of the base media file with the visual features of the modified media file and generate labels based on this comparison. For example, if the effect is Image Overlay, then the base media file can be any video or image that is suitable to be processed by the LLM and the modified media file can be the base media of the base media file modified by an overlaid image included with the effect. The prompt provided to the pretrained LLM 602 can be similar in many respects to the prompt discussed herein in relation to FIG. 4A. However, in this instance, the prompt may include instructions such as “Task: create a detailed document for the “Image Overlay” effect. The document should be created based on the visual differences between the base media file and the modified media file. The document should include the following sections . . . .” In response to receiving the prompt, the pretrained LLM 602 can generate a set of labels based on identifying differences between the base media file and the modified media file. In some examples, the pretrained LLM 602 can be provided with more than one base media files and corresponding more than one modified media files that are the base media files modified with the effect. Providing multiple base media files and multiple modified media files can improve the accuracy of the set of labels generated by the pretrained LLM 602.

The labels generated by the system 600 using the approach that compares a base media file with a modified file that represents the base media file modified by the effect can provide more accurate labels than the approach that processes only modified media to generate labels (e.g., FIG. 5). For example, where only modified media is used, the LLM 602 the common variations in the media (e.g., daylight v. darkness) may be misconstrued by the LLM as an effect, even though the variations were not part of the media effect. As a result, the LLM may generate labels for the common variations in addition to generating labels for the common features of the modified videos. The approach discussed in relation to system 600 shown in FIG. 6 may reduce or mitigate the risk of the LLM generating labels that do not accurately represent the media effect. That is, the LLM comparing videos with and without media effects may generate more accurate labels than the LLM processing already modified videos.

The quality of the set of labels generated by the machine learning models can be affected by the quality of the prompt provided to the model. Therefore, it may be important to generate a prompt that results in a high quality set of labels. In some examples, the prompt can be engineered such that the resulting labels make searching for the corresponding effect easy. In one approach to engineering the prompts, a benchmark dataset can be created that includes a plurality of effects (e.g., randomly selected from a larger set of effects) and corresponding media files (e.g., videos modified with the effect). Measuring success for effect labeling can be based on defining precision and recall metrics. For example, recall can be described as whether the machine learning model is able to generate enough labels to make searching for the effect easy (quantification of recall is described further below). Engineering the prompts can be implanted at the backend servers (e.g., backend servers 114, FIG. 1), and in particular at the effects label generation engine 116, or at a dedicated prompt generation engine (not shown).

One step in engineering the prompt can include defining a confusion matrix. For example, TP (True Positive) can refer to the generated label being a good search n-gram (good outcome), FP (False Positive) can refer to the generated label being a bad search n-gram (bad outcome), FN (False Negative) can refer to good search n-gram missing from generated output (bad outcome), and TN (True Negative) can refer to bad search n-gram missing from the generated output (good outcome). At times, it can be difficult to measure the missing output. Thus, to quantify recall, a golden set of labels can be created for every effect in the benchmark dataset. An LLM can also be used to expand on the golden set of labels with a larger breadth (e.g., using LLM-based synonym expansion). This golden set of labels can be referred to as the precise set and are the labels that should ideally appear in the output.

Similarly, to quantify precision, a negative set of labels can be created for each effect in the dataset. LLM-based antonym expansion can be used to generate a large set of negative labels. This negative set of labels can be referred to as the imprecise set. These are the labels that should ideally never appear in the output. The true positives, true negatives, false positives, and false negatives can be calculated using set theory based on the following expressions:

TP=Output∩Precise

FP=Output∩Imprecise

FN=Precise-Output

Recall and precision can be calculated based on the following expressions:

$$precision = \frac{TP}{TP + FP}$$

$$recall = \frac{TP}{TP + FN}$$

An automatic prompt optimization process can be employed to create the optimized effect labeling prompt. For example, the optimization process can include the following steps. The initial prompt is fed to the LLM-under-evaluation along with samples from the benchmark dataset. Each effect's labels are scored using a custom scorer and summary statistics can be computed. The scores of the labels can reflect the precision and recall metrics discussed above. A few examples from the dataset and their generated labels can be sampled and a critique prompt can be used to ask a critique-LLM for a few reasons why the score was not 100%. These critiques can then be combined with a revision prompt to ask a prompt-LLM to come up with a few candidate prompts that address the critiques. The process is then repeated for each of the candidate prompts. Each prompt's summary statistics and scores can be tracked throughout the process so that the best prompts can be retrieved at the end of the process. In some examples, the same LLM may be used for the LLM-under-evaluation, the critique-LLM, and the prompt-LLM if the LLM is not biased (i.e., unaware of previous interactions).

Referring again to FIG. 1, the effects search engine 112 can utilize user profile to enhance the search for the user. For example, the effects search engine 112 upon receiving a query from the user device 102, can determine the identity of the user, and based on the user identity request or access user profile information (in some instances, the front-end 112 may provide the effects search engine 112 with the user profile along with the search query). The effect search engine can use the user profile to expand or modify the keywords included in the search query. For example, if the user profile indicates that the user is interested in sport A and sports team B, then the effects search engine 112 can utilize the one or more ML models 120 to generate additional keywords such as the sport(s) related to the sport A or the sports team B, the location associated with the sports team B, the location of the user, the video viewing history of the user, etc. The effects search engine can utilize these keywords to search for effects in the media effects database 126. As the search is based on the user profile, in addition to the keywords provided in the user query, the search can result in media effects that are more closely related to the user's interests. For example, the user profile-based keywords can match labels related to the sports team B, location of the sports team B, the name of the sport A, thereby resulting in identification of media effects related to the user profile. The user can therefore be presented with media effects that are more relevant to the user's interest.

Using the user profile to carry out a search for media effects can reduce the need for the user to enter keywords specific to the interests of the user or carry out repeated searches that add additional keywords that are related to the user's interest. Thus, the amount of time and data transmitted between the user device 102 and the effects platform 110 can be reduced. In some implementations, the effects search engine 122, prior to searching the effects database 126, prompts the one or more ML models 120 to generate user related keywords based on the provided description of the user profile. One example of such a prompt can include: “generate keywords for searching media effects based on the provided description of the user profile.” The one or more ML models 120 (e.g., an LLM) can then generate the user related keywords, which the effects search engine 122 can use, in addition to the keywords included in the search query, to search for media effects in the media effects database 126.

In some examples, the user related keywords can be used as categories in the search results or in the catalog of media effects provided to the user. For example, the search results or the catalog can be organized based on tabs that correspond to one or more user related keywords. In this manner, the user is presented with effects labels that are organized based on the user's interest and can reduce the time needed for the user to select the appropriate media effect.

The following discussion is focused on the various processes related to generation of effects labels.

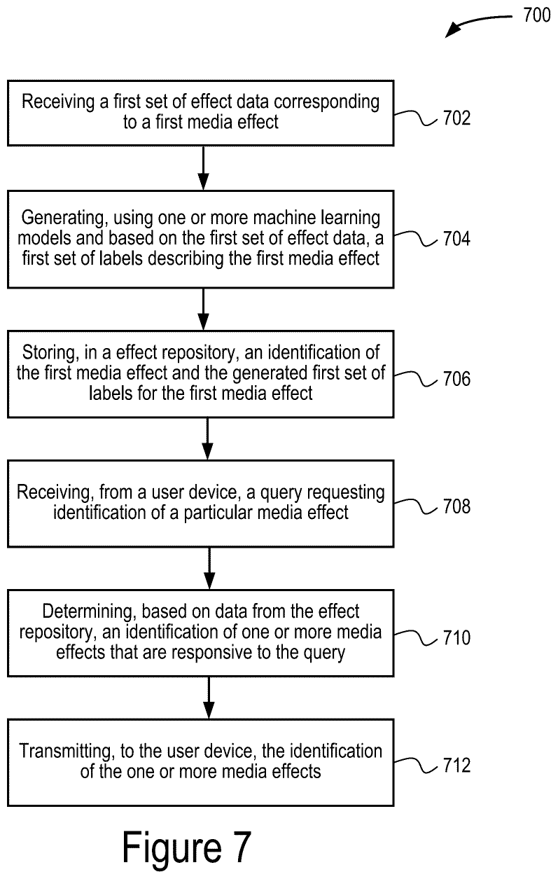

FIG. 7 shows a flow diagram of an example process 700 for generating labels for effects. The example process 700 can be executed by any suitable data processing apparatus and is described illustratively as being executed by the effects label generation engine 116.

The process 700 includes receiving a first set of effect data corresponding to a first media effect (702). At least one example of this process step has been discussed herein. For example, referring to FIG. 3, the effects label generation engine 116 can receive effects data from an effects creation application 302 or from an effects database 126, where the effects data can include a first set of effect data. The first set of effect data can include a description of a corresponding media effect. For example, the description can include a title, a brief description, provider's labels, etc., of the media effect. The first set of data may also include accompanying media, such as in the case of the “Image Overlay” effect where the effect can be overlayed on a user provided video or image.

The process 700 also includes generating, using one or more machine learning models and based on the first set of effect data, a first set of labels describing the first media effect (704). At least one example of this process step has been discussed herein. For example, FIGS. 3, 5, and 6 each show machine learning models such as LLMs for generating labels associated with a media effect. The machine learning models generate the effect labels based on the effects data received from the provider, from an effects creating application (e.g., the effects creation application 302), or from an effects database 126. Based on the effects data, the machine learning models generate the set of labels.

The process 700 further includes storing, in an effect repository, an identification of the first media effect and the generated first set of labels for the first media effect (706). At least one example of this process step has been discussed herein. For example, FIG. 3 shows the effects label generation engine 116 stores the generated set of labels for a media effect in an effects label database 124 (also referred to as an effects repository). The labels are stored in association with the identity of the corresponding media effect. For example, in some instances, the label data can be stored in an inverted index where each label can point to all the associated media effects.

The process 700 also includes receiving, from a user device, a query requesting identification of a particular media effect (708). At least one example of this process stage has been discussed herein. For example, referring to FIG. 1, the user device 102, via the user-application 102-A, can send a query to the effects platform 110, where the query requests identification of a particular media effect. The query can be entered by the user on a user interface of the user application 102-A. One example of such a user interface is described in relation to FIG. 2B, where a field 254 is provided for the user to enter keywords of the effect that the user is looking for.

The process 700 further includes determining, based on data from the effect repository, an identification of one or more media effects that are responsive to the query (710). At least one example of this process stage has been discussed herein. For example, referring to FIGS. 1 and 3, the effects search engine 122 can search the effects label database 124 for identification of effects related to the keywords included in the query provided by the user. In some examples, the effects search engine 122 can match the keywords provided in the query with labels stored in the effects label database to determine the identity of effects that are associated with the keyword. The identification of the one or more media effects associated with the matching label can be used to obtain effects data associated with the media effects. In some examples, the effects search engine 122 can match embeddings of the keywords with embeddings of the labels stored in the effects label database to determine the identity of the effects that are associated with the keywords.

The process 700 also includes transmitting, to the user device, the identification of the one or more media effects (712). At least one example of this process stage has been discussed herein. For example, referring to FIGS. 1 and 3, the effects search engine 122 can provide the front end servers 112 with the identification of the effects. The front end servers 112, in turn, can transmit the identification of the effects to the user device 102.

The process 700 can also include generating an inverted index using the generated set of labels for the plurality of media effects and determining the identification of the one or more media effects based on the query and the inverted index. As discussed in relation to FIG. 3, the effects label generation engine 116 can store the generated labels and the identity of the corresponding media effect in an inverted index stored in the effects label database 124. The inverted index can include a list of labels and corresponding entries that point to all the media effects that are described by that label. For example, referring to FIG. 4B, the effects label generation engine 116 can store the labels listed in the Aliases/Synonyms section in the inverted index, and for each label include an entry that points to the identification or includes the identification of the media effect “Image Overlay.”

The process 700 can also include storing at least a portion of the inverted index at the user device. In some examples, the inverted index can be of sufficiently small size that can justify the inverted index being stored in the user device. For example, the inverted index can have a size that is less than 100 MB, which can be considered to be sufficiently small to justify storing in the user device. In some instances, only a portion of the inverted index can be stored in the user device. When the user enters keywords to search for effects, the user application 102A can search the inverted index stored on the user device to identify the effects related to the keywords. As the query is processed locally at the device, the response time of identifying the media effects can be substantially less than if the inverted index were stored at the effects platform 110. In instances where only a portion of the inverted index is stored in the user device, the user application 102-A may first determine whether there are labels matching the keywords in the inverted index stored in the user device. If no match is found on the user device, the user application 102A can then send the query to the effects platform 110.

The process 700 can also include generating a plurality of media effect embeddings corresponding to the plurality of media effects, each media effect embedding of the plurality of media effect embeddings being a vector representation of the label data of the corresponding media effect of the plurality of media effects; generating a query embedding based on the query requesting identification of a particular media effect, the query embedding being a vector representation of the query; and identifying the media effect embedding from the plurality of media effect embedding based on determining a dot product or a nearest neighbor similarity between the media effect embedding and the query embedding. In some examples, the effects platform 110 can support searching for effects media based on keywords provided by the user based on embeddings. The effects label generation engine 116, or some other entity in the effects platform 110, can generate embeddings of the generated labels, and store the embeddings of the labels in the effects label database 124. Further, the effects search engine 122 can generate embeddings of the keywords entered by the user. The effects search engine 122 can then determine, in the embeddings vector space, the embeddings of the labels that are related to the embeddings of the keywords. For example, the effects search engine 122 can determine a dot product or a nearest neighbor similarity between the media effect embedding and the query embedding. The labels or the media effects associated with each of the identified nearest neighbor effect embeddings can be identified and provided to the user device.

In some examples, the first set of effect data includes an image of the effect, and wherein the one or more machine learning models includes an image labeling model that generates the first set of labels based on the image of the effect. As discussed in relation to FIG. 5, the image labeling model 502 can receive effects assets, such as an image of the effect, and generate an intermediate set of labels. In some examples, the effects label generation engine 116 can store the labels generated by the image labeling model 502 in the effects label database 124. During search, the effects search engine 122 can search for matches between the keywords and the intermediate set of labels stored in the effects label database 124.

In some examples, the first set of effect data includes a video modified by the corresponding effect, wherein the one or more machine learning models include a video labeling model that generates the first set of labels based on the video. As discussed in relation to FIG. 5, the video labeling model 504 can generate an intermediate set of labels based on videos that have been modified by the effect. The effects label generation engine 116 can store in the effects label database 124 the intermediate set of labels generated by the video labeling model 504. During search, the effects search engine 122 can search for matches between the keywords and the intermediate set of labels stored in the effects label database 124.

In some examples, the video labeling model can be pretrained on a plurality of media files modified by the corresponding effect from a plurality of media effects. In particular, a training dataset can include videos that have been modified by the effect and the corresponding labels. Once trained, the video labeling model can generate labels as part of an inference operation based on input videos modified by effects.

In some examples, the first set of labels is an expanded first set of labels, and where the process further includes generating a first intermediate set of labels using the one or more machine learning models and generating the expanded first set of labels based on a large language model receiving as input the first intermediate set of labels. As discussed in relation to FIG. 5, the labels generated by the image labeling model 502 and the video labeling model 504 can be an intermediate set of labels. The pretrained LLM 506 can generate an expanded set of labels based on these intermediate sets of labels. The expanded set of labels can include related words or synonyms of the labels in the intermediate set of labels. Having an expanded set of labels can represent a relatively more comprehensive and accurate description of the effect.

In some examples, the effect data can include at least one of titles, description, author labels, user labels, or location labels. Referring to FIG. 5, the pretrained LLM can receive effect data such as titles, description, author labels, and location labels. The pretrained LLM 506, in addition to the intermediate set of labels provided by the image labeling model 502 and the video labeling model 503, can use as input the additional effect data to generate the extended set of labels. The titles, description, author labels, user labels, or location labels can be included by the provider when creating the effect. This information can be helpful in improving the accuracy of the labels generated by the pretrained LLM 506.

In some examples, the first set of labels is generated using the one or more machine learning models based additionally on a user profile of a user authoring the first media effect, the user profile including at least one of video viewing history or the user or a location of the user. As discussed herein, the effects label generation engine 116 can receive as input user profiles to more accurately generate labels related to the effects. For example, the effects label generation engine 116 can consider the provider's video viewing history or the provider's location to generate the set of labels.

In some examples, a set of user related keywords can be generated based on a user profile associated with the user that communicates the search query to the effects platform 110. One or more machine learning models, e.g., ML models 120, can be utilized to generate the keywords. For example, the effects search engine 122 can instruct the one or more machine learning models to generate a set of user related keywords based on the user profile associated with the query. The effects search engine 122 can use the set of user related keywords in addition to the keywords included in the search query to search for media effects in the media effects database 126.

In some examples, the first set of media effect data includes at least one base media file and corresponding at least one modified media file generated based on the at least one base media file modified by the first effect, the generative AI model generating the first set of labels in response to a zero-shot prompt instructing the generative AI to identify differences between the at least one base media file and the corresponding at least one modified media file. As discussed herein in relation to FIG. 6, one approach to generating labels for an effect is to have the one or more machine learning models to identify differences between a base media file and a based media file that has been modified by the effect. The first set of media effect data can include pairs of base media files and corresponding modified media files generated based on the base media file modified by the effect. The one or more machine learning model (such as a generative AI model) can generate the first set of labels in response to a zero-shot prompt that instructs the model to identify differences between the base media file and the modified media file and generate labels based on these identified differences.

In some examples, the prompt can instruct the machine learning model to generate the set of labels based additionally on media effect metadata, which can include information such as title, brief description, provider's labels, etc.

In some examples, the prompt can additionally instruct the one or more machine learning models to take into account a provider profile of the provider that authored the media effect in generating the first set of labels. The user profile can include at least one of a video viewing history and a location of the provider.

The generation of accurate labels discussed herein can facilitate a more efficient search for the media effects associated with those labels. In particular, generating accurate labels can reduce the number of times the user may have to run queries until media effects accurately related to the search keywords are received. Moreover, presenting the user with search results that are categorized based on the keywords, the labels of the media effects, or the user profile can enhance the interface on which the user is presented the search results. This improves the convenience and latency with which the user can identify the media effects the user is looking for.

The components and processes discussed herein can be implemented on a computing system. In particular, a computing system including a computing device and/or a mobile computing device can be used to implement the techniques described herein. For example, one or more processes, electronic design tools, and data can be implemented on or stored in the computing device or the mobile computing device.

The computing device is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device includes a processor, a memory, a storage device, a high-speed interface connecting to the memory and multiple high-speed expansion ports, and a low-speed interface connecting to a low-speed expansion port and the storage device. Each of the processor, the memory, the storage device, the high-speed interface, the high-speed expansion ports, and the low-speed interface, are interconnected using various busses, and may be mounted on a common motherboard or in other manners as appropriate. The processor can process instructions for execution within the computing device, including instructions stored in the memory or on the storage device to display graphical information for a GUI on an external input/output device, such as a display coupled to the high-speed interface. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor is a single threaded processor. In some implementations, the processor is a multi-threaded processor. In some implementations, the processor is a quantum computer.

The memory stores information within the computing device. In some implementations, the memory is a volatile memory unit or units. In some implementations, the memory is a non-volatile memory unit or units. The memory may also be another form of computer-readable medium, such as a magnetic or optical disk.

The storage device is capable of providing mass storage for the computing device. In some implementations, the storage device may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor), perform one or more methods, such as those described above. The instructions can also be stored by one or more storage devices such as computer- or machine-readable mediums (for example, the memory, the storage device, or memory on the processor). The high-speed interface manages bandwidth-intensive operations for the computing device, while the low-speed interface manages lower bandwidth-intensive operations. Such allocation of functions is an example only. In some implementations, the high-speed interface is coupled to the memory, the display (e.g., through a graphics processor or accelerator), and to the high-speed expansion ports, which may accept various expansion cards (not shown). In the implementation, the low-speed interface is coupled to the storage device and the low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device may be implemented in a number of different forms, as shown in the figure. For example, it may be implemented as a standard server, or multiple times in a group of such servers. In addition, it may be implemented in a personal computer such as a laptop computer. It may also be implemented as part of a rack server system. Alternatively, components from the computing device may be combined with other components in a mobile device, such as a mobile computing device. Each of such devices may include one or more of the computing device and the mobile computing device, and an entire system may be made up of multiple computing devices communicating with each other.

The mobile computing device includes a processor, a memory, an input/output device such as a display, a communication interface, and a transceiver, among other components. The mobile computing device may also be provided with a storage device, such as a micro-drive or other device, to provide additional storage. Each of the processor, the memory, the display, the communication interface, and the transceiver, are interconnected using various buses, and several of the components may be mounted on a common motherboard or in other manners as appropriate.

The processor can execute instructions within the mobile computing device, including instructions stored in the memory. The processor may be implemented as a chipset of chips that include separate and multiple analog and digital processors. The processor may provide, for example, for coordination of the other components of the mobile computing device, such as control of user interfaces, applications run by the mobile computing device, and wireless communication by the mobile computing device.

The processor may communicate with a user through a control interface and a display interface coupled to the display. The display may be, for example, a TFT (Thin-Film-Transistor Liquid Crystal Display) display or an OLED (Organic Light Emitting Diode) display, or other appropriate display technology. The display interface may include appropriate circuitry for driving the display to present graphical and other information to a user. The control interface may receive commands from a user and convert them for submission to the processor. In addition, an external interface may provide communication with the processor, so as to enable near area communication of the mobile computing device with other devices. The external interface may provide, for example, for wired communication in some implementations, or for wireless communication in other implementations, and multiple interfaces may also be used.

The memory stores information within the mobile computing device. The memory can be implemented as one or more of a computer-readable medium or media, a volatile memory unit or units, or a non-volatile memory unit or units. An expansion memory may also be provided and connected to the mobile computing device through an expansion interface, which may include, for example, a SIMM (Single In Line Memory Module) card interface. The expansion memory may provide extra storage space for the mobile computing device or may also store applications or other information for the mobile computing device. Specifically, the expansion memory may include instructions to carry out or supplement the processes described herein and may include secure information also. Thus, for example, the expansion memory may be provided as a security module for the mobile computing device and may be programmed with instructions that permit secure use of the mobile computing device. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor), perform one or more methods, such as those described above. The instructions can also be stored by one or more storage devices, such as one or more computer- or machine-readable mediums (for example, the memory, the expansion memory, or memory on the processor). In some implementations, the instructions can be received in a propagated signal, for example, over the transceiver or the external interface.

The mobile computing device may communicate wirelessly through the communication interface, which may include digital signal processing circuitry in some cases. The communication interface may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 4G/5G/6G cellular, among others. Such communication may occur, for example, through the transceiver using a radio frequency. In addition, short-range communication may occur, such as using a Bluetooth, Wi-Fi, or other such transceiver (not shown). In addition, a GPS (Global Positioning System) receiver module may provide additional navigation- and location-related wireless data to the mobile computing device, which may be used as appropriate by applications running on the mobile computing device.

The mobile computing device may also communicate audibly using an audio codec, which may receive spoken information from a user and convert it to usable digital information. The audio codec may likewise generate audible sound for a user, such as through a speaker, e.g., in a handset of the mobile computing device. Such sound may include sound from voice telephone calls, may include recorded sound (e.g., voice messages, music files, among others) and may also include sound generated by applications operating on the mobile computing device.

The mobile computing device may be implemented in a number of different forms, as shown in the figure. For example, it may be implemented as a cellular telephone. It may also be implemented as part of a smart-phone, personal digital assistant, or other similar mobile device.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.-

A computer program which may also be referred to or described as a program, software, a software application, an app, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows can also be performed by special purpose logic circuitry, e.g., an FPGA or an ASIC, or by a combination of special purpose logic circuitry and one or more programmed computers. Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.-While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system, comprising
one or more processors; and
a memory comprising:
an effect repository storing effect identification data identifying a plurality of media effects and corresponding label data for the plurality of media effects, wherein the label data includes a respective set of labels descriptive of each of the plurality of media effects and wherein a media effect is a visual effect that is operable to modify a digital media file, and stored instructions that when executed by the one or more processors, cause the one or more processors to perform operations, comprising:
receiving a first set of effect data corresponding to a first media effect;
generating, using one or more machine learning models and based on the first set of effect data, a first set of labels describing the first media effect;
storing, in the effect repository, an identification of the first media effect and the generated first set of labels for the first media effect;
receiving, from a user device, a query requesting identification of a particular media effect;
determining, based on data from the effect repository, an identification of one or more media effects that are responsive to the query; and
transmitting, to the user device, the identification of the one or more media effects.

2. The system of claim 1, the operations further comprising:
generating, an inverted index using the generated set of labels for the plurality of media effects, and
determining the identification of the one or more media effects based on the query and the inverted index.

3. The system of claim 2, the operations further comprising:
storing at least a portion of the inverted index at the user device.

4. The system of claim 1, the operations further comprising:
generating a plurality of media effect embeddings corresponding to the plurality of media effects, each media effect embedding of the plurality of media effect embeddings being a vector representation of the label data of the corresponding media effect of the plurality of media effects;
generating a query embedding based on the query requesting identification of a particular media effect, the query embedding being a vector representation of the query; and
identifying the media effect embedding from the plurality of media effect embedding based on determining a dot product or a nearest neighbor similarity between the media effect embedding and the query embedding.

5. The system of claim 1, wherein the first set of effect data includes an image of the effect, and wherein the one or more machine learning models includes an image labeling model that generates the first set of labels based on the image of the effect.

6. The system of claim 1, wherein the first set of effect data includes a video modified by the corresponding effect, wherein the one or more machine learning models include a video labeling model that generates the first set of labels based on the video.

7. The system of claim 6, wherein the video labeling model is pretrained on a plurality of media files modified by a corresponding effect from a plurality of media effects.

8. The system of claim 1, wherein the first set of labels is an expanded first set of labels, the operations further comprising:
generating a first intermediate set of labels using the one or more machine learning models, and
generating the expanded first set of labels based on a large language model receiving as input the first intermediate set of labels.

9. The system of claim 1, wherein the effect data includes at least one of titles, description, author labels, user labels, or location labels.

10. The system of claim 1, wherein the first set of labels is generated using the one or more machine learning models based additionally on a user profile of a user authoring the first media effect, the user profile including at least one of video viewing history or the user or a location of the user.

11. The system of claim 1, the operations further comprising:
generating, using the one or more machine learning models, a set of user related keywords based on a user profile associated with the query, the user profile including at least one of a video viewing history of the user or a location of the user; and
determining, based on the data from the effect repository, the identification of one or more media effects that are responsive to the query and the set of user related keywords.

12. The system of claim 1, wherein the one or more machine learning models includes a multimodal generative artificial intelligence (generative AI) model,
wherein the first set of media effect data includes at least one base media file and corresponding at least one modified media file generated based on the at least one base media file modified by the first effect, and
wherein the generative AI model generating the first set of labels in response to a zero-shot prompt instructing the generative AI to identify differences between the at least one base media file and the corresponding at least one modified media file.

13. The system of claim 1, wherein the zero-shot prompt includes instructions for generating the set of labels based additionally on media effect metadata.

14. The system of claim 13, wherein the zero-shot prompt additionally instructs the multimodal generative-AI model to account for a user profile of a user authoring the media effect in generating the first set of labels, the user profile including at least one of a video viewing history of the user or a location of the user.

15. One or more non-transitory computer-readable storage media storing instructions that when executed by one or more processors cause the one or more processors to perform operations comprising:
receiving a first set of effect data corresponding to a first media effect, wherein a media effect is a visual effect that is operable to modify a digital media file;
generating, using one or more machine learning models and based on the first set of effect data, a first set of labels describing the first media effect;
storing, in an effect repository, an identification of the first media effect and the generated first set of labels for the first media effect, wherein the effect repository stores effect identification data identifying a plurality of media effects and corresponding label data for the plurality of media effects, wherein the label data includes a respective set of labels descriptive of each of the plurality of media effects;
receiving, from a user device, a query requesting identification of a particular media effect;
determining, based on data from the effect repository, an identification of one or more media effects that are responsive to the query; and
transmitting, to the user device, the identification of the one or more media effects.

16. The storage media of claim 15, the operations further comprising:
generating, an inverted index using the generated set of labels for the plurality of media effects, and
determining the identification of the one or more media effects based on the query and the inverted index.

17. The storage media of claim 16, the operations further comprising:
storing at least a portion of the inverted index at the user device.

18. The storage media of claim 15, the operations further comprising:
generating a plurality of media effect embeddings corresponding to the plurality of media effects, each media effect embedding of the plurality of media effect embeddings being a vector representation of the label data of the corresponding media effect of the plurality of media effects;
generating a query embedding based on the query requesting identification of a particular media effect, the query embedding being a vector representation of the query; and
identifying the media effect embedding from the plurality of media effect embedding based on determining a dot product or a nearest neighbor similarity between the media effect embedding and the query embedding.

19. The storage media of claim 15, wherein the first set of effect data includes an image of the effect, and wherein the one or more machine learning models includes an image labeling model that generates the first set of labels based on the image of the effect.

20. The storage media of claim 15, wherein the first set of effect data includes a video modified by the corresponding effect, wherein the one or more machine learning models include a video labeling model that generates the first set of labels based on the video.

21. The storage media of claim 20, wherein the video labeling model is pretrained on a plurality of media files modified by a corresponding effect from a plurality of media effects.

22. The storage media of claim 15, wherein the first set of labels is an expanded first set of labels, the operations further comprising:
generating a first intermediate set of labels using the one or more machine learning models, and
generating the expanded first set of labels based on a large language model receiving as input the first intermediate set of labels.

23. The storage media of claim 15, wherein the effect data includes at least one of titles, description, author labels, user labels, or location labels.

24. The storage media of claim 15, wherein the first set of labels is generated using the one or more machine learning models based additionally on a user profile of a user authoring the first media effect, the user profile including at least one of video viewing history or the user or a location of the user.

25. The storage media of claim 15, the operations further comprising:
generating, using the one or more machine learning models, a set of user related keywords based on a user profile associated with the query, the user profile including at least one of a video viewing history of the user or a location of the user; and
determining, based on the data from the effect repository, the identification of one or more media effects that are responsive to the query and the set of user related keywords.

26. The storage media of claim 15, wherein the one or more machine learning models includes a multimodal generative artificial intelligence (generative AI) model,
wherein the first set of media effect data includes at least one base media file and corresponding at least one modified media file generated based on the at least one base media file modified by the first effect, and
wherein the generative AI model generating the first set of labels in response to a zero-shot prompt instructing the generative AI to identify differences between the at least one base media file and the corresponding at least one modified media file.

27. The storage media of claim 15, wherein the zero-shot prompt includes instructions for generating the set of labels based additionally on media effect metadata.

28. The storage media of claim 27, wherein the zero-shot prompt additionally instructs the multimodal generative-AI model to account for a user profile of a user authoring the media effect in generating the first set of labels, the user profile including at least one of a video viewing history of the user or a location of the user.

29. A method for execution on a computing system for management of media effects and respective media labels, comprising:
receiving, at the computing system, a first set of effect data corresponding to a first media effect, wherein a media effect is a visual effect that is operable to modify a digital media file;
generating, at the computing system, using one or more machine learning models and based on the first set of effect data, a first set of labels describing the first media effect;
storing, in an effect repository communicably coupled with the computing system, an identification of the first media effect and the generated first set of labels for the first media effect, wherein the effect repository stores effect identification data identifying a plurality of media effects and corresponding label data for the plurality of media effects, wherein the label data includes a respective set of labels descriptive of each of the plurality of media effects;
receiving, at the computing system from a user device, a query requesting identification of a particular media effect;
determining, at the computing system, based on data from the effect repository, an identification of one or more media effects that are responsive to the query; and
transmitting, by the computing system to the user device, the identification of the one or more media effects.

30. The method of claim 29, further comprising:
generating, at the computing system, an inverted index using the generated set of labels for the plurality of media effects, and
determining, at the computing system, the identification of the one or more media effects based on the query and the inverted index.

31. The method of claim 30, further comprising:
transmitting, by the computing system to the user device, at least a portion of the inverted index for storage at the user device.

32. The method of claim 29, further comprising:
generating, at the computing system, a plurality of media effect embeddings corresponding to the plurality of media effects, each media effect embedding of the plurality of media effect embeddings being a vector representation of the label data of the corresponding media effect of the plurality of media effects;
generating, at the computing system, a query embedding based on the query requesting identification of a particular media effect, the query embedding being a vector representation of the query; and
identifying, at the computing system, the media effect embedding from the plurality of media effect embedding based on determining a dot product or a nearest neighbor similarity between the media effect embedding and the query embedding.

33. The method of claim 29, wherein the first set of effect data includes an image of the effect, and wherein the one or more machine learning models includes an image labeling model that generates the first set of labels based on the image of the effect.

34. The method of claim 29, wherein the first set of effect data includes a video modified by the corresponding effect, wherein the one or more machine learning models include a video labeling model that generates the first set of labels based on the video.

35. The method of claim 34, wherein the video labeling model is pretrained on a plurality of media files modified by a corresponding effect from a plurality of media effects.

36. The method of claim 29, wherein the first set of labels is an expanded first set of labels, the method further comprising:
generating, at the computing system, a first intermediate set of labels using the one or more machine learning models, and
generating, at the computing system, the expanded first set of labels based on a large language model receiving as input the first intermediate set of labels.

37. The method of claim 29, wherein the effect data includes at least one of titles, description, author labels, user labels, or location labels.

38. The method of claim 29, wherein the first set of labels is generated using the one or more machine learning models based additionally on a user profile of a user authoring the first media effect, the user profile including at least one of video viewing history or the user or a location of the user.

39. The method of claim 29, further comprising:
generating, at the computing system, using the one or more machine learning models, a set of user related keywords based on a user profile associated with the query, the user profile including at least one of a video viewing history of the user or a location of the user; and
determining, at the computing system, based on the data from the effect repository, the identification of one or more media effects that are responsive to the query and the set of user related keywords.

40. The method of claim 29, wherein the one or more machine learning models includes a multimodal generative artificial intelligence (generative AI) model,
wherein the first set of media effect data includes at least one base media file and corresponding at least one modified media file generated based on the at least one base media file modified by the first effect, and
wherein the generative AI model generating the first set of labels in response to a zero-shot prompt instructing the generative AI to identify differences between the at least one base media file and the corresponding at least one modified media file.

41. The method of claim 29, wherein the zero-shot prompt includes instructions for generating the set of labels based additionally on media effect metadata.

42. The method of claim 41, wherein the zero-shot prompt additionally instructs the multimodal generative-AI model to account for a user profile of a user authoring the media effect in generating the first set of labels, the user profile including at least one of a video viewing history of the user or a location of the user.
